(19) United States
(12) Patent Application Publication
(10) Pub. No.: US 2007/0196088 A1
(43) Pub. Date: Aug. 23, 2007

(54) Electronic device capable of preventing an electromagnetic signal radiated by an antenna thereof from being attenuated thereby

(75) Inventors: Tiao-Hsing Tsai, Yungho City (TW); Chieh-Ping Chiu, Er Lun Hsiang (TW); Chih-Wei Liao, Su Ao Township (TW)

Correspondence Address: LADAS & PARRY, Suite 2100, 5670 Wilshire Boulevard, Los Angeles, CA, 90036-5679, US

(73) Assignee: Quanta Computer Inc.

(21) Appl. No.: 11/486,257

(22) Filed: Jul. 12, 2006

(30) Foreign Application Priority Data
Feb. 21, 2006 (TW) 095105754

(51) Int. Cl. G03B 17/00

(52) U.S. Cl. 396/56

(57) ABSTRACT

An electronic device includes a casing, an antenna, a signal attenuating member, and a signal reflecting member. The antenna is disposed in the casing for radiating an electromagnetic signal. The signal attenuating member is mounted on the casing. The signal reflecting member is disposed between the antenna and the signal attenuating member, is free of physical contact with the antenna, and reflects a portion of the electromagnetic signal, which is radiated by the antenna toward the signal attenuating member, away from the signal attenuating member.

### CROSS-REFERENCE TO RELATED APPLICATION

This application claims priority of Taiwanese application No. 095105754, filed on Feb. 21, 2006.

### BACKGROUND OF THE INVENTION

1. Field of the Invention

The invention relates to an electronic device, more particularly to an electronic device that prevents an electromagnetic signal radiated by an antenna thereof from being attenuated thereby.

2. Description of the Related Art

FIG. 1 illustrates a conventional electronic device 1 that includes a casing 11, a printed circuit board 12, an antenna 13, a camera 14, and a mirror 15. The antenna 13 is disposed in the casing 11 and is mounted on the printed circuit board 12. The camera 14 is mounted on the printed circuit board 12 and is operable so as to take photographs. The mirror 15 is mounted on the casing 11, partially overlaps the antenna 13, and is used during operation of the camera 14 for self-portrait.

The aforementioned conventional electronic device 1 is disadvantageous in that the mirror 15 attenuates a portion of an electromagnetic signal radiated by the antenna 13, thereby reducing an antenna gain of the antenna 13.

### SUMMARY OF THE INVENTION

Therefore, the object of the present invention is to provide an electronic device that can overcome the aforesaid drawback of the prior art.

According to the present invention, an electronic device comprises a casing, an antenna, a signal attenuating member, and a signal reflecting member. The antenna is disposed in the casing for radiating an electromagnetic signal. The signal attenuating member is mounted on the casing. The signal reflecting member is disposed between the antenna and the signal attenuating member, is free of physical contact with the antenna, and reflects a portion of the electromagnetic signal, which is radiated by the antenna toward the signal attenuating member, away from the signal attenuating member.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic view of a conventional electronic device;

FIG. 2 is a fragmentary schematic view of the preferred embodiment of an electronic device according to the present invention;

FIG. 3 is a fragmentary schematic view to illustrate relative positions of an antenna, a signal attenuating member, and a signal reflecting member of the preferred embodiment;

FIG. 4 is a fragmentary schematic view of the preferred embodiment to illustrate signal trace of a portion of an electromagnetic signal radiated by the antenna of the preferred embodiment; and

FIG. 5 is a plot to illustrate an antenna gain of the preferred embodiment.

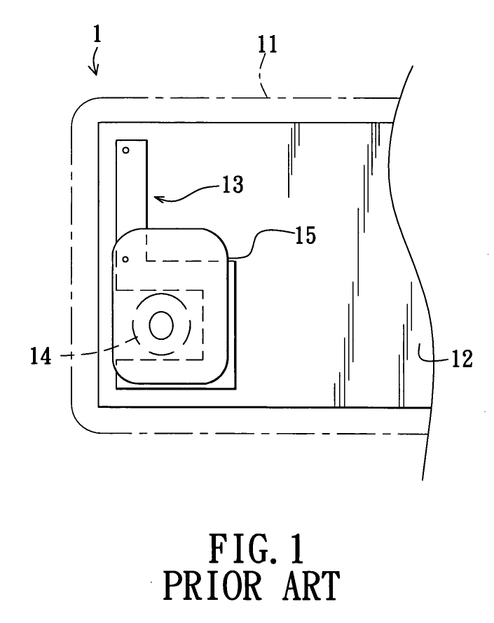

### DETAILED DESCRIPTION OF THE PREFERRED EMBODIMENT

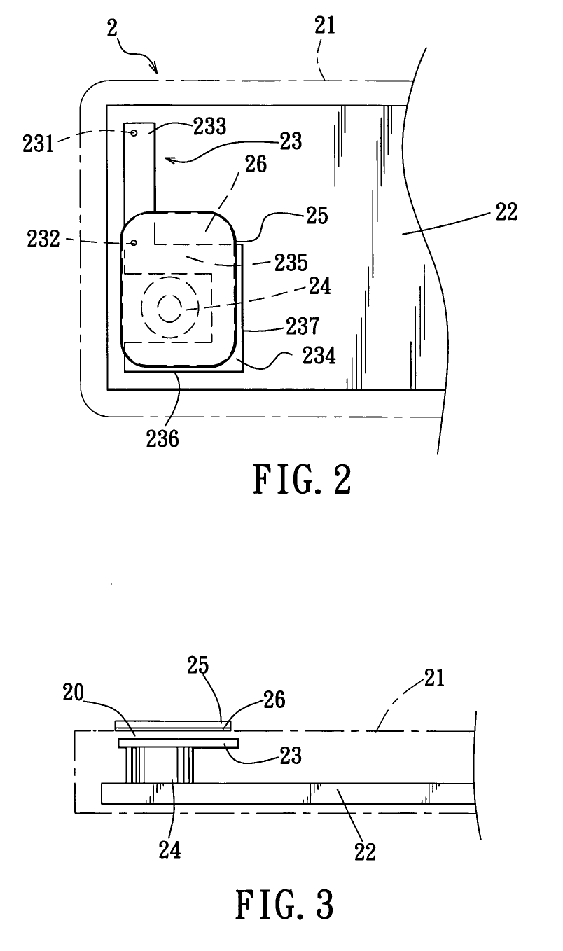

Referring to FIGS. 2 and 3, the preferred embodiment of an electronic device 2 according to this invention is shown to include a casing 21, an antenna 23, a signal attenuating member 25, and a signal reflecting member 26.

The electronic device 2 of this embodiment is a communications device, such as a mobile phone.

The electronic device 2 further includes a circuit board 22 disposed in the casing 21, and an image processing unit 24 mounted on the circuit board 22.

The antenna 23 is operable within the GSM900 bandwidth, is disposed in the casing 21, and is mounted on the circuit board 22. It is noted that a gap 20 exists between the casing 21 and the antenna 23, as best shown in FIG. 3. In this embodiment, the antenna 23 has a straight segment 233 and a U-shaped segment 234. The straight segment 233 of the antenna 23 has a first end that is provided with a feeding point 231, and a second end that is opposite to the first end thereof and that is provided with a grounding point 232. The U-shaped segment 234 of the antenna 23 has parallel first and second sections 235, 236, each of which has opposite first and second ends, and a third section 237 that extends parallel to the straight segment 233 of the antenna 23 and that interconnects the second ends of the first and second sections 235, 236 of the U-shaped segment 234 of the antenna 23. The first end of the first section 235 of the U-shaped segment 234 of the antenna 23 is connected to the second end of the straight segment 233 of the antenna 23.

The image processing unit 24 is disposed in an accommodating space defined by the first, second and third sections 235, 236, 237 of the U-shaped segment 234 of the antenna 23. In this embodiment, the image processing unit 24 includes a camera (not shown) that is used to take photographs in a known manner.

The signal attenuating member 25 is made from a poor conductivity material, is disposed externally of and is mounted on the casing 21, and overlaps the U-shaped segment 234 of the antenna 23. In this embodiment, the signal attenuating member 25 is a mirror that is used during operation of the camera for self portrait. In an alternative embodiment, the signal attenuating member 25 is a sticker that is attached to the casing 21 and that indicates a brand name of the electronic device 2.

The signal reflecting member 26 is made from metal, preferably copper, is disposed between the antenna 23 and the signal attenuating member 25, and is free of physical contact with the antenna 23. In this embodiment, the signal reflecting member 26 is disposed externally of the casing 21 and is attached to the signal attenuating member 25. In an alternative embodiment, the signal reflecting member 26 is disposed in and is attached to the casing 21.

It is noted that the signal reflecting member 26 has size and shape that correspond to those of the signal attenuating member 25.

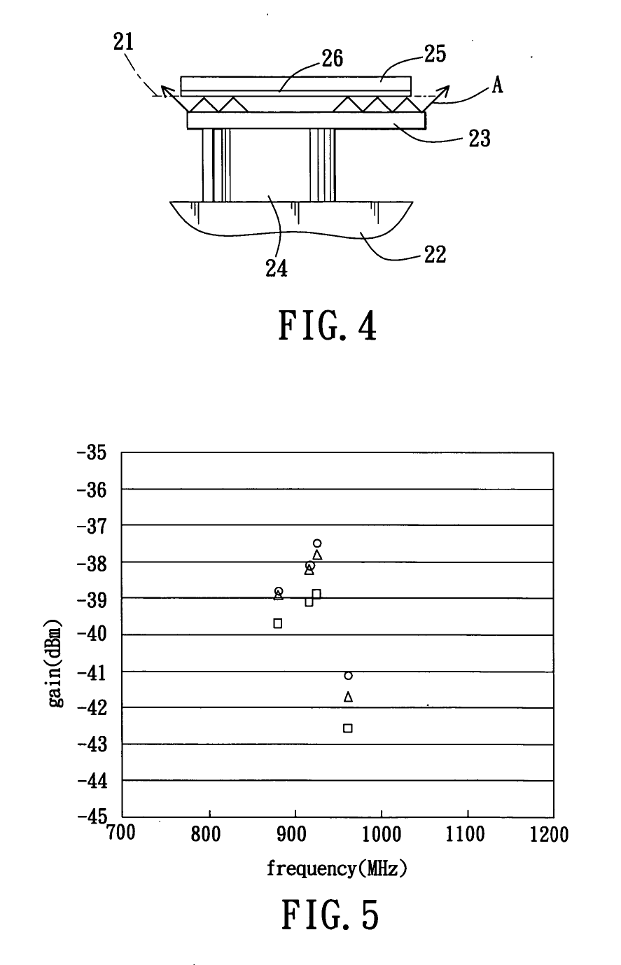

In operation, with further reference to FIG. 4, when the antenna 23 radiates an electromagnetic signal, a portion of the electromagnetic signal, which is radiated by the antenna 23 toward the signal attenuating member 25 (indicated by the signal trace (A) in FIG. 4) is reflected by the signal reflecting member 26 away from the signal attenuating member 25.

Based from experimental results, the electronic device 2 of this invention has an antenna gain (denoted by symbol “Δ” in FIG. 5) that is approximately equal to an antenna gain (denoted by symbol “◯” in FIG. 5) of a conventional electronic device (not shown) which is dispensed with the signal attenuating member 25 and the signal reflecting member 26, and that is higher by approximately one dBm than an antenna gain (denoted by symbol “□” in FIG. 5) of a conventional electronic device which includes the signal attenuating member 25 but is dispensed with the signal reflecting member 26.

It has thus been shown that the electronic device 2 of this invention includes an antenna 23, a signal attenuating member 25, and a signal reflecting member 26 that is disposed between the antenna 23 and the signal attenuating member 25. As such, a portion of an electromagnetic signal (A), which is radiated by the antenna 23 toward the signal attenuating member 25, is reflected by the signal reflecting member 26 away from the signal attenuating member 25. Therefore, the portion of the electromagnetic signal (A) is prevented from being attenuated by the signal attenuating member 25.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electronic device, comprising:
a casing;
an antenna disposed in said casing for radiating an electromagnetic signal;
a signal attenuating member mounted on said casing; and
a signal reflecting member disposed between said antenna and said signal attenuating member, being free of physical contact with said antenna, and reflecting a portion of the electromagnetic signal, which is radiated by said antenna toward said signal attenuating member, away from said signal attenuating member.

2. The electronic device as claimed in claim 1, further comprising a circuit board disposed in said casing, said antenna being mounted on said circuit board.

3. The electronic device as claimed in claim 1, wherein said signal reflecting member is attached to said signal attenuating member.

4. The electronic device as claimed in claim 1, wherein said signal reflecting member is made from metal.

5. The electronic device as claimed in claim 1, further comprising a camera for taking photographs, said signal attenuating member being a mirror that is used during operation of said camera for self portrait.

6. The electronic device as claimed in claim 1, wherein said signal reflecting member has a shape that corresponds to that of said signal attenuating member.
